(19) United States
(12) Patent Application Publication
(10) Pub. No.: US 2007/0007738 A1
(43) Pub. Date: Jan. 11, 2007

(54) Folding leg brace for a wheelbarrow

(75) Inventor: Barry Albert, Dillsburg, PA (US)

Correspondence Address: David C. Jenkins;Eckert Seamans Cherin & Mellott, LLC, 44th Floor, 600 Grant Street, Pittsburgh, PA, 15219, US

(73) Assignee: Ames True Temper, Inc., Camp Hill, PA (US)

(21) Appl. No.: 11/353,440

(22) Filed: Feb. 14, 2006

Related U.S. Application Data
(60) Provisional application No. 60/696,577, filed on Jul. 5, 2005.

(51) Int. Cl. B62B 1/00

(52) U.S. Cl. 280/47.31

(57) ABSTRACT

The present invention provides a wheelbarrow having a collapsible frame assembly. The wheelbarrow also includes a hopper and a wheel. The frame assembly includes a wheel brace assembly, a first adjustable leg assembly, a second adjustable leg assembly, a first handle member and a second handle member. The wheel brace assembly is narrow relative to the hopper. The first adjustable leg assembly and the second adjustable leg assembly are pivotally coupled to the wheel brace assembly. The first and second leg assemblies are each structured to move between a first configuration and a second configuration. In the first configuration, the first and second leg assemblies are structured to be closer to the centerline of the wheelbarrow, and/or frame assembly, so that the width of the legs/brace sub-assembly is relatively narrow.

### CROSS SECTION TO RELATED APPLICATION

This application claims priority under 35 U.S.C. §119(e) to U.S. Provisional Patent Application Ser. No. 60/696,577, filed Jul. 5, 2005, entitled, FOLDING LEG BRACE FOR A WHEELBARROW.

### BACKGROUND OF THE INVENTION

1. Field of the Invention

This invention relates to wheelbarrows and, more specifically, a wheelbarrow having a scissor-like leg brace structured to reduce the time and effort required to assemble the wheelbarrow.

2. Background Information

Wheelbarrows are well known in the art. Typically, a wheelbarrow included a hopper and a frame assembly having a curved yoke, a wheel, and a brace. The yoke included two elongated members typically joined by a nose guard at the forward most point. The elongated members were shaped to have a portion that curved downwardly to form a footpad and then curved upwardly to form handles. The hopper rested on, or in between, a medial portion of the yoke members. The wheel was disposed on an axle that extended between the yoke members adjacent to the front end of the yoke and behind the nose guard. The brace typically included at least one rigid member that held the yoke members in a spaced relation. Other braces added rigidity to the yoke members.

In this configuration, and when the wheelbarrow is not in motion, the wheelbarrow rests on the footpads and the wheel. Friction between the ground and the leg assemblies typically arrests the rolling movement of the wheel. To move the wheelbarrow, the user lifts on the handle portion of the yoke so that footpads are raised off the ground. The wheelbarrow may then be moved on the wheel. The hopper on the wheelbarrow may be used to transport various items, and is particularly adapted to hold granulated materials such as, but not limited to, sand, gravel and cement.

Wheelbarrows were sold in a working configuration as well as a collapsed configuration. In the collapsed configuration, the frame assembly was generally individual components stored in a reduced size box. The box further included a “parts bag” holding the fastening hardware as well as other components, such as the wheel. A purchaser of the collapsed wheelbarrow was required to assemble the wheelbarrow into a working configuration. Thus, the user was required to assemble the wheelbarrow using the fastening hardware to connect the frame elements, the hopper and the wheel. As some people dislike assembling hardware, this is a disadvantage.

There is, therefore, a need for a wheelbarrow having a reduced number of assembly hardware components.

There is a further need for a wheelbarrow having adjustable leg assemblies and a scissor-like adjustable brace assembly that may be moved from a first, collapsed configuration to a second, expanded configuration.

There is a further need for a wheelbarrow that may be collapsed for packaging while maintaining a substantially completed frame assembly.

### SUMMARY OF THE INVENTION

These needs, and others, are met by the present invention which provides a wheelbarrow having a collapsible frame assembly. The wheelbarrow also includes a hopper and a wheel. The frame assembly includes a wheel brace assembly, a first adjustable leg assembly, a second adjustable leg assembly, a first handle member and a second handle member. The wheel brace assembly is narrow relative to the hopper. The first adjustable leg assembly and the second adjustable leg assembly are pivotally coupled to the wheel brace assembly. The first and second leg assemblies are each structured to move between a first configuration and a second configuration. In the first configuration, the first and second leg assemblies are structured to be closer to the centerline of the wheelbarrow, and/or frame assembly, so that the width of the legs/brace sub-assembly is relatively narrow. As such, the legs/brace sub-assembly may be placed in a container that is substantially smaller than the size of the expanded frame assembly. In the second configuration, the first and second leg assemblies are structured to be pivoted outwardly so that the width of the legs/brace sub-assembly is almost as wide as the hopper.

The first and second leg assemblies are further coupled to an adjustable brace assembly. The adjustable brace assembly has a first member and a second member. The adjustable brace assembly first member and second member are each an elongated member having a first end, a second end, and a medial portion. The first and second members are pivotally coupled to each other at the medial portion, thereby forming a scissor-like assembly. The first and second members are structured to move between a first configuration and a second configuration relative to each other. In the first configuration, the first and second members almost overlap each other in a first direction, thereby having a narrow profile. In the second configuration, the first and second members are rotated to almost overlap each other in a second direction, thereby having a wide profile.

The first member first end is pivotally coupled to the first adjustable leg assembly and the second member first end is pivotally coupled to the second adjustable leg assembly. Thus, when the adjustable brace members are in the first configuration, the first adjustable leg assembly and the second adjustable leg assembly are in the first configuration, and when the adjustable brace members are moved into the second configuration, the first adjustable leg assembly and the second adjustable leg assembly are moved into the second configuration. In this manner the frame legs/brace sub-assembly may be quickly converted from a collapsed position to an expanded position. When the handle members are attached to the leg assemblies, the wheelbarrow is essentially complete. Thus, when the frame assembly is removed from a container, a user is required to attach a limited number of components as much of the frame assembly is already assembled.

### BRIEF DESCRIPTION OF THE DRAWINGS

A full understanding of the invention can be gained from the following description of the preferred embodiments when read in conjunction with the accompanying drawings in which:

FIG. 1 is an isometric view of a wheelbarrow.

FIG. 2 is a detailed view of a leg/brace sub-assembly.

### DESCRIPTION OF THE PREFERRED EMBODIMENTS

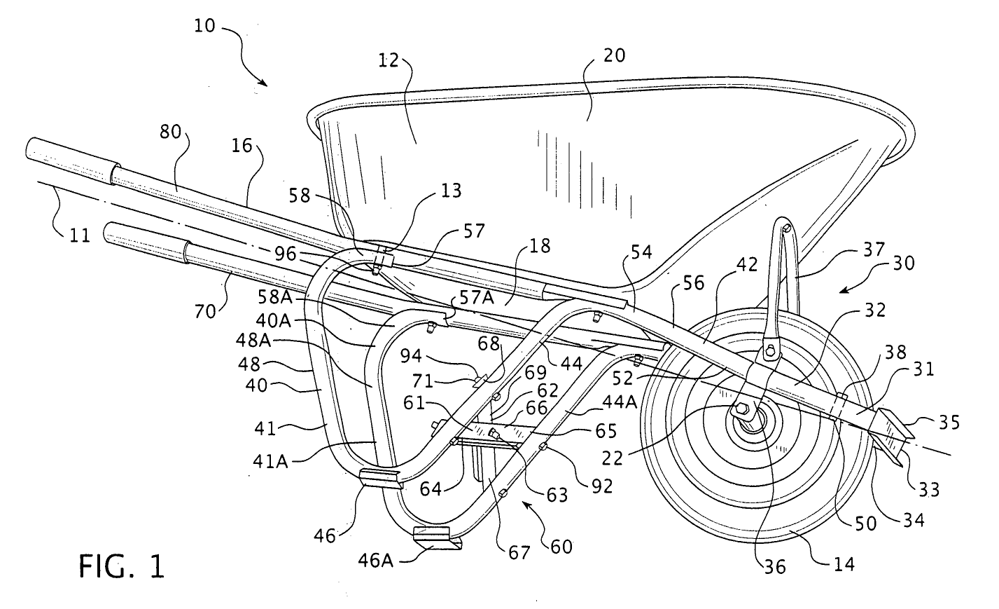

As shown in FIG. 1, a wheelbarrow 10 includes a hopper 12, a wheel 14 and a frame assembly 16. The wheelbarrow 10 is generally symmetrical about a longitudinal centerline 11. The hopper 12 includes a generally flat base plate 18 having a depending, flared peripheral sidewall 20. The hopper base plate 18 includes a plurality of fastener openings 13. The wheel 14 includes an axle 22 structured to be attached to the frame assembly 16.

The frame assembly 16 includes a wheel brace assembly 30, a first adjustable leg assembly 40, a second adjustable leg assembly 40A, an adjustable brace assembly 60, a first handle member 70 and a second handle member 80. The wheel brace assembly 30 includes a frame assembly 31 having a first tine member 32, a flat bight member 33, a second tine member 34, a bight guard 35, two wheel brackets 36, and a hopper support 37. Each tine member 32, 34 also has two opposing pivot pin openings 38 disposed adjacent to the distal end of each tine member 32, 34. The pivot pin openings 38 extend between about the highest and lowest locations on the tine member 32, 34. That is, in the normal orientation of the wheelbarrow 10, the pivot pin openings 38 extend generally vertically. The first tine member 32, flat bight member 33, and second tine member 34 are coupled at generally right angles to form a generally right angled U-shape. The bight guard 35 is coupled to the outer side of the bight member 33 and is structured to protect the bight when the wheelbarrow 10 is upended. The wheel brackets 36 are coupled, one each, to the first and second tine members 32, 34. The wheel axle 22 is structured to extend between the wheel brackets 36 thereby positioning the wheel 14 within the U-shape wheel brace frame assembly 31. The wheel brace assembly 30 is narrow relative to the hopper 12. The hopper support 37 is pivotally coupled to the wheel brackets 36 as well. Prior to final assembly, the hopper support 37 may be oriented generally parallel to the first and second tines 32, 34, thereby reducing the profile of the wheel brace assembly 30. During final assembly, the hopper support 37 may be oriented generally perpendicular to the first and second tines 32, 34 and be coupled to the hopper 12.

The first and second adjustable leg assemblies 40, 40A are generally mirror images of each other. As such, only the first adjustable leg assembly 40 will be described in detail below; however, it is understood that the second adjustable leg assembly 40A includes identical elements that will be identified with the same reference number followed by the letter “A.” The first adjustable leg assembly 40 has a plurality of generally rigid, elongated members 41 including a first, wheel brace member 42, a first leg portion 44, a footpad 46, a second leg portion 48, and a pivot pin 50. The first, wheel brace member 42 has a front end 52 and a back end 54. Each wheel brace member 42 may have one or more laterally flared S-shaped portions 56 having a middle portion that curves outwardly thereby increasing the distance of the first, wheel brace member back end 54 from the centerline 11. That is, when the first adjustable leg assembly 40 is coupled to the wheel brace assembly 30, the first, wheel brace member front end 52 is closer to the centerline 11 than the first, wheel brace member back end 54. The first, wheel brace member 42 is structured to be coupled to the wheel brace assembly 30 by the pivot pin 50. The first leg portion 44 extends downwardly from the first, wheel brace member 42. The second leg portion 48 extends upwardly from the lowest point on the first leg portion 44. The location where the first leg portion 44 and the second leg portion 48 are joined is the lowest point on the first adjustable leg assembly 40. The footpad 46 is disposed at the location where the first leg portion 44 and the second leg portion 48 are joined. The distal end 57 of the second leg portion 48 may be curved into a platform 58. The pivot pin 50 is structured to extend through the vertically aligned pivot pin openings 38 on the wheel brace assembly 30.

The adjustable brace assembly 60 includes a first elongated, rigid member 61, a second elongated, rigid member 62 and a pivot pin 63. The first member 61 has a first end 64, a second end 65, and a medial portion 66. The second member 62 has a first end 67 a second end 68, and a medial portion 69. While the two members 61, 62 may be pivotally coupled at the second ends 65, 68, thereby forming a generally V-shaped assembly, in the preferred embodiment, the two members 61, 62 are pivotally coupled together with the pivot pin 50 passing through the medial portions 66, 69, thereby forming a scissor-like assembly. The second ends 65, 68 may be formed into hooks 71.

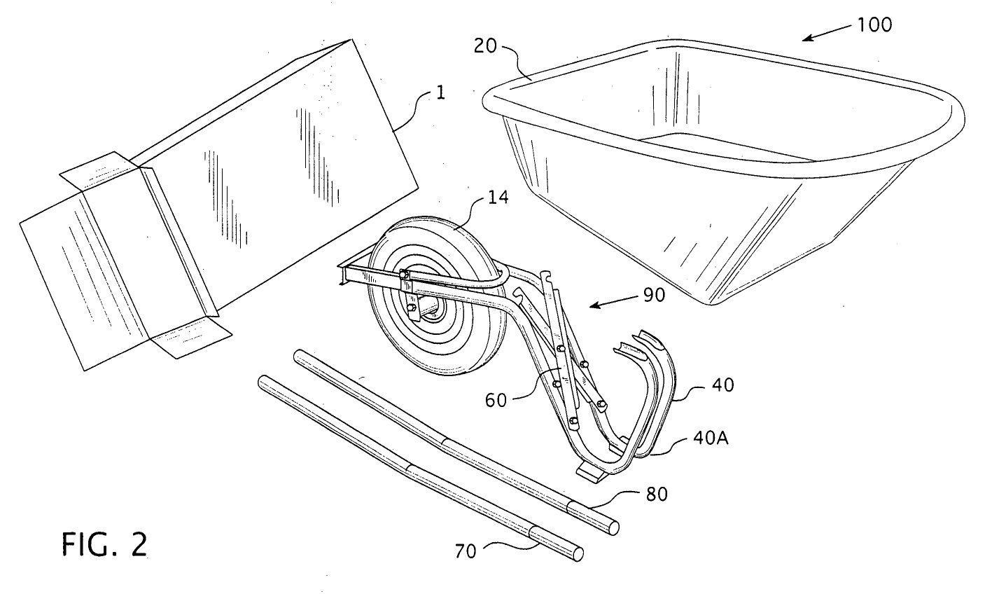

As shown in FIG. 2, the wheel 14, wheel brace assembly 30, first adjustable leg assembly 40, second adjustable leg assembly 40A, and adjustable brace assembly 60 may be preassembled as a leg/brace sub-assembly 90. That is, the wheel axle 22 is disposed between, and coupled to, the wheel brackets 36 thereby positioning the wheel 14 within the U-shaped wheel brace frame assembly 31. The first and second adjustable leg assemblies 40, 40A are each coupled to the wheel brace assembly 30 with the leg assembly pivot pins 50 each passing through a set of generally vertically aligned wheel brace assembly pivot pin openings 38. The adjustable brace assembly 60 is coupled to the first and second adjustable leg assemblies 40, 40A with the first member first end 64 coupled to the first adjustable leg assembly first leg portion 44 and the second member first end 67 coupled to the second adjustable leg assembly first leg portion 44A. The first and second adjustable leg assembly first leg portions 44, 44A may have fasteners 92 disposed therethrough with posts 94 extending adjacent to the adjustable brace assembly 60.

Thus, the leg/brace sub-assembly 90 may be placed in a narrow configuration or a wide configuration. That is, first and second adjustable leg assemblies 40, 40A are structured to move between a first configuration, wherein the first and second adjustable leg assemblies 40, 40A are close to the centerline 11, and a second configuration, wherein the first and second adjustable leg assemblies 40, 40A, especially the second leg portion distal ends 57, 57A, are spaced from the centerline 11 (as shown in FIG. 1). In the preferred embodiment, the motion of the first and second adjustable leg assemblies 40, 40A is a pivoting motion about the leg assembly pivot pins 50. Similarly, the adjustable brace assembly 60 is structured to move between a first configuration wherein the two members 61, 62 are at an acute angle relative to the centerline 11 and a second configuration wherein the two members 61, 62 are at an obtuse angle relative to the centerline 11. As the two members 61, 62 move into the second configuration, the hooks 71 on the second ends 65, 68 may be coupled to the posts 94 and secured with a nut. Due to the mechanical connections between the first and second adjustable leg assemblies 40, 40A and the adjustable brace assembly 60, the motion between the first configurations and the second configurations occur simultaneously.

Thus, the wheelbarrow 10 maybe sold as a substantially assembled kit 100. The kit 100 includes the hopper 12, two handles 70, 80 and the leg/brace sub-assembly 90. A user may simply remove the leg/brace sub-assembly 90, which is in the first configuration, from a reduced size box 1 as a substantially assembled unit. The user then pulls the first and second adjustable leg assemblies 40, 40A apart into the second configuration, thereby causing the adjustable brace assembly 60 to move into the second configuration as well. The user may then secure the adjustable brace assembly 60 with two fasteners 92 disposed on the posts 94. The wheelbarrow 10 is completed by coupling the first handle member 70 to the first adjustable leg assembly 40 and the second handle member 80 to the second adjustable leg assembly 40A. The handle members 70, 80, preferably, extend across to platforms 58, 58A and to the wheel brace members 42, 42A. The handle members 70, 80 may be secured with fasteners 96 extending through the hopper fastener openings 13 and into fastener openings on the frame assembly 16. Finally, the hopper support 37 is pivoted upwardly and coupled to the hopper 12.

While specific embodiments of the invention have been described in detail, it will be appreciated by those skilled in the art that various modifications and alternatives to those details could be developed in light of the overall teachings of the disclosure. Accordingly, the particular arrangements disclosed are meant to be illustrative only and not limiting as to the scope of invention which is to be given the full breadth of the claims appended and any and all equivalents thereof.

What is claimed is:

1. A wheelbarrow frame assembly comprising:
a first adjustable leg assembly structured to move between a first configuration and a second configuration;
a second adjustable leg assembly structured to move between a first configuration and a second configuration;
a wheel brace assembly;
said first adjustable leg assembly and said second adjustable leg assembly movably coupled to said wheel brace assembly;
an adjustable brace assembly coupled to said first adjustable leg assembly and said second adjustable leg assembly, said adjustable brace assembly structured to move between a first configuration and a second configuration; and
wherein when said adjustable brace assembly is in said first configuration, said first adjustable leg assembly and said second adjustable leg assembly are in said first configuration, and when said adjustable brace assembly is moved into said second configuration, said first adjustable leg assembly and said second adjustable leg assembly are moved into said second configuration.

2. The wheelbarrow frame assembly of claim 1 wherein said adjustable brace assembly has a first member and a second member, said adjustable brace assembly first member and a second member are each being an elongated member having a first end, a second end, and a medial portion, said first and second members pivotally coupled to each other, said first and second members structured to move between a first configuration and a second configuration relative to each other.

3. The wheelbarrow frame assembly of claim 2 wherein:
said first member first end pivotally coupled to said first adjustable leg assembly and said second member first end pivotally coupled to said second adjustable leg assembly; and
wherein when said adjustable brace members are in said first configuration, said first adjustable leg assembly and said second adjustable leg assembly are in said first configuration, and when said adjustable brace members are moved into said second configuration, said first adjustable leg assembly and said second adjustable leg assembly are moved into said second configuration.

4. The wheelbarrow frame assembly of claim 3 wherein said adjustable brace assembly first member medial portion is pivotally coupled to said adjustable brace assembly second member medial portion.

5. The wheelbarrow frame assembly of claim 4 wherein:
when said adjustable brace members are in said second configuration, said adjustable brace assembly first member second end is coupled to said second adjustable leg assembly; and
when said adjustable brace members are in said second configuration, said adjustable brace assembly second member second end is coupled to said first adjustable leg assembly.

6. The wheelbarrow frame assembly of claim 5 wherein:
said adjustable brace assembly first member second end and said adjustable brace assembly second member second end each have a hook;
said first adjustable leg assembly includes a post;
said second adjustable leg assembly includes a post;
when said adjustable brace members are in said second configuration, said adjustable brace assembly first member second end hook is coupled to said second adjustable leg assembly post; and
when said adjustable brace members are in said second configuration, said adjustable brace assembly second member second end hook is coupled to said first adjustable leg assembly post.

7. The wheelbarrow frame assembly of claim 6 wherein:
said first adjustable leg assembly post is part of a fastener;
said second adjustable leg assembly post is part of a fastener; and
wherein said adjustable brace assembly first member second end and said adjustable brace assembly second member second end may be secured by said fasteners.

8. The wheelbarrow frame assembly of claim 3 wherein said adjustable brace assembly first member second end is pivotally coupled to said adjustable brace assembly second member second end.

9. A wheelbarrow comprising:
a frame assembly having a first adjustable leg assembly, a second adjustable leg assembly and a wheel brace assembly;
a hopper coupled to said frame assembly;
a wheel rotatably coupled to said wheel brace assembly;
said first adjustable leg assembly structured to move between a first configuration and a second configuration;
said second adjustable leg assembly structured to move between a first configuration and a second configuration;
said first adjustable leg assembly and said second adjustable leg assembly movably coupled to said wheel brace assembly;
an adjustable brace assembly coupled to said first adjustable leg assembly and said second adjustable leg assembly, said adjustable brace assembly structured to move between a first configuration and a second configuration; and
wherein when said adjustable brace assembly is in said first configuration, said first adjustable leg assembly and said second adjustable leg assembly are in said first configuration, and when said adjustable brace assembly is moved into said second configuration, said first adjustable leg assembly and said second adjustable leg assembly are moved into said second configuration.

10. The wheelbarrow of claim 9 wherein said adjustable brace assembly has a first member and a second member, said adjustable brace assembly first member and a second member are each being an elongated member having a first end, a second end, and a medial portion, said first and second members pivotally coupled to each other, said first and second members structured to move between a first configuration and a second configuration relative to each other.

11. The wheelbarrow of claim 10 wherein:
said first member first end pivotally coupled to said first adjustable leg assembly and said second member first end pivotally coupled to said second adjustable leg assembly; and
wherein when said adjustable brace members are in said first configuration, said first adjustable leg assembly and said second adjustable leg assembly are in said first configuration, and when said adjustable brace members are moved into said second configuration, said first adjustable leg assembly and said second adjustable leg assembly are moved into said second configuration.

12. The wheelbarrow of claim 11 wherein said adjustable brace assembly first member medial portion is pivotally coupled to said adjustable brace assembly second member medial portion.

13. The wheelbarrow of claim 12 wherein:
when said adjustable brace members are in said second configuration, said adjustable brace assembly first member second end is coupled to said second adjustable leg assembly; and
when said adjustable brace members are in said second configuration, said adjustable brace assembly second member second end is coupled to said first adjustable leg assembly.

14. The wheelbarrow of claim 13 wherein:
said adjustable brace assembly first member second end and said adjustable brace assembly second member second end each have a hook;
said first adjustable leg assembly includes a post;
said second adjustable leg assembly includes a post;
when said adjustable brace members are in said second configuration, said adjustable brace assembly first member second end hook is coupled to said second adjustable leg assembly post; and
when said adjustable brace members are in said second configuration, said adjustable brace assembly second member second end book is coupled to said first adjustable leg assembly post.

15. The wheelbarrow frame assembly of claim 14 wherein:
said first adjustable leg assembly post is part of a fastener;
said second adjustable leg assembly post is part of a fastener; and
wherein said adjustable brace assembly first member second end and said adjustable brace assembly second member second end may be secured by said fasteners.

16. The wheelbarrow frame assembly of claim 11 wherein said adjustable brace assembly first member second end is pivotally coupled to said adjustable brace assembly second member second end.

17. A kit for a wheelbarrow comprising:
a leg/brace sub-assembly having a first adjustable leg assembly, a second adjustable leg assembly, a wheel brace assembly and a wheel rotatably coupled to said wheel brace assembly;
a hopper structured to be coupled to said leg/brace sub-assembly;
a first handle member structured to be coupled to said leg/brace sub-assembly;
a second handle member structured to be coupled to said leg/brace sub-assembly;
said first adjustable leg assembly structured to move between a first configuration and a second configuration;
said second adjustable leg assembly structured to move between a first configuration and a second configuration;
said first adjustable leg assembly and said second adjustable leg assembly movably coupled to said wheel brace assembly;
an adjustable brace assembly coupled to said first adjustable leg assembly and said second adjustable leg assembly, said adjustable brace assembly structured to move between a first configuration and a second configuration; and
wherein when said adjustable brace assembly is in said first configuration, said first adjustable leg assembly and said second adjustable leg assembly are in said first configuration, and when said adjustable brace assembly is moved into said second configuration, said first adjustable leg assembly and said second adjustable leg assembly are moved into said second configuration.

18. The wheelbarrow frame assembly of claim 17 wherein said adjustable brace assembly has a first member and a second member, said adjustable brace assembly first member and a second member are each being an elongated member having a first end, a second end, and a medial portion, said first and second members pivotally coupled to each other, said first and second members structured to move between a first configuration and a second configuration relative to each other.

19. The kit for a wheelbarrow of claim 18 wherein:
said first member first end pivotally coupled to said first adjustable leg assembly and said second member first end pivotally coupled to said second adjustable leg assembly; and
wherein when said adjustable brace members are in said first configuration, said first adjustable leg assembly and said second adjustable leg assembly are in said first configuration, and when said adjustable brace members are moved into said second configuration, said first adjustable leg assembly and said second adjustable leg assembly are moved into said second configuration.

20. The kit for a wheelbarrow of claim 19 wherein:
when said adjustable brace members are in said second configuration, said adjustable brace assembly first member second end is coupled to said second adjustable leg assembly; and
when said adjustable brace members are in said second configuration, said adjustable brace assembly second member second end is coupled to said first adjustable leg assembly.
